(19) United States
(12) Patent Application Publication
(10) Pub. No.: US 2013/0132715 A1
(43) Pub. Date: May 23, 2013

(54) STORAGE DEVICE WITH A COMMUNICATIONS FUNCTION

(71) Applicants: Hong-Chi YU, Kaohsiung City (TW); Mao-Ting Chang, Kaohsiung City (TW)

(72) Inventors: Hong-Chi YU, Kaohsiung City (TW); Mao-Ting Chang, Kaohsiung City (TW)

(73) Assignee: WALTON ADVANCED ENGINEERING INC., Kaohsiung (TW)

(21) Appl. No.: 13/348,684

(22) Filed: Jan. 12, 2012

(30) Foreign Application Priority Data
Nov. 22, 2011 (TW) 100142793

(51) Int. Cl. H04L 29/06; G06F 21/00

(52) U.S. Cl. 713/152; 726/3

(57) ABSTRACT

The present invention relates to a storage device with a communications function which comprises an integrated circuit module and an application program. The integrated circuit module comprises at least a USB connector, at least a substrate, at least a controller and at least a memory in which there is at least an authentication code; the application program comprises a communications module and a transmission module wherein the communications module is used to receive digital information of at least a data input device in a computer for both the authentication code and the digital information, which has been received by the communications module, transmitted to at least a server or at least a peer by the transmission module.

### BACKGROUND OF THE INVENTION

1) Field of the Invention

The present invention provides one communications device which uses software to link Internet and delivers safety communications by means of hardware authentication codes.

2) Description of the Prior Art

The popularity of Internet has made live communications software prevalent and normalized people's Internet-based live communications behavior. Live communications software with convenient functions for transmission of texts, video signals, messages and files has created a new commercial model beyond conventional facsimile, lowered cost of video communications and increased some communications speeds of E-mails comparatively.

To login and link a remote server, a user indispensably enters an account number and a password to confirm this user via regular live communications software. With the connection completed, the packets transferred from information by communications protocols can be forwarded to Internet via local networks.

A content communicated may include personal or official business information in which there are some dialogues inconveniently disclosed. During information transferred to packets and forwarded to Internet by means of live communications software, the packets may be extracted by any person with malicious intent to spy on content communicated.

Furthermore, an account number or a password to be entered into any suspicious electronic equipment may be stolen so that personal security is threatened.

### SUMMARY OF THE INVENTION

To solve the said problems, the present invention provides a storage device with a communications function in which there are at least an integrated circuit module and an application program used in reading at least one authentication code of the integrated circuit module's one memory to replace an account number and a password for login to a server and uses the computer's at least one data input device to enter communication-required data which will be further decoded by the application program and transmitted to a server or a peer for reduction of security-related issues observed in traditional live communications software.

Accordingly, the principle object of the present invention is to provide a storage device with a communications function which is characteristic of live communications & link and no process to enter an account number & a password for reduction of risks unfavorable to security during login to a server.

The other object of the present invention is to provide a storage device with a communications function which is effective in encrypting live communications information to make sure of confidentiality of packets routed and communicated through networks.

The further object of the present invention is to provide a storage device with a communications function which is in favor of fast and convenient usage of one user who needs not to create a private account number.

The yet other object of the present invention is to provide a storage device with a communications function which comprises a hot key to quickly link any peer.

The yet still other object of the present invention is to provide a storage device with a communications function which is effective in easily monitoring network or link quality.

The yet still further object of the present invention is to provide a storage device with a communications function which has a user-friendly offline message design for information transmissible.

To this end, the major technical measures used in the present invention are embodied with the following schemes. The present invention is a storage device with a communications function which comprises at least an integrated circuit module and an application program: the integrated circuit module comprises at least a USB connector, at least a substrate, at least a controller and at least a memory wherein the substrate carries the USB connector, the controller and the memory for the controller electrically connected between the USB connector and the memory via the substrate and the memory comprising at least an authentication code; the application program comprises a communications module and a transmission module wherein the former receives digital information of at least one data input device in a computer and the latter transmits both the digital information received by the former and the authentication code to at least one server or at least one peer.

The objects and the technical issues in connection with the present invention can be further embodied with the following technical measures.

In the said storage device with a communications function, the integrated circuit module comprises a control unit which is able to issue an electronic signal to the controller.

In the said storage device with a communications function, the application program comprises an encryption module which is used to encrypt or decrypt packets received or to be transmitted.

In the said storage device with a communications function, the application program comprises a signal detecting module which is used to analyze quality of one connection to the server or the peer via the application program.

In the said storage device with a communications function, the application program comprises an assistant positioning module used in analyzing the geographic position of a network connection.

In the said storage device with a communications function, the server comprises a peer list used in managing connections between the peers.

In the said storage device with a communications function, the server comprises an offline message module and an offline message buffer for offline messages transmitted between the peers.

In the said storage device with a communications function, the integrated circuit module comprises a body case.

In contrast to prior arts, the present invention is effective in (1) login via live communications software quickly completed by means of a hardware authentication code; (2) encrypted packets safely transmitted via live communications software; (3) hotline function completed with a hot key; (4) intensity of signals used in realizing status of network-based transmission; (5) information transmitted by offline signals which have been remained in a server.

### DETAILED DESCRIPTIONS OF THE PREFERRED EMBODIMENTS

For objects, characteristics, and effects obviously and easily understood, the preferred embodiments of the present invention are particularly interpreted as follows:

The preferred embodiments of the present invention of a storage device with a communications function (1) are shown from FIG. 1 to FIG. 6. Referring to FIGS. 1 and 2 which illustrate the present invention comprises at least an integrated circuit module (10) and an application program (20).

In this regard, the integrated circuit module (10) encased with a Chip-On-Board (COB) package or a Surface-Mount-Technology (SMT) package and comprising at least a USB connector (11), at least a substrate (12), at least a controller (13) and at least a memory (14): the substrate (12) is used to carry the USB connector (11), the controller (13) and the memory (14) for the controller (13) electrically connected between the USB connector (11) and the memory (14) via the substrate (12) and the memory (14) comprising at least an authentication code (141).

In this embodiment, the substrate (12) is a wire board, preferably a printed circuit board (PCB) such as a single layer PCB or a multi-layer PCB. Wherein, the substrate (12) has an upper surface corresponding to an underside where a plurality of fingers are disposed in the upper surface. Moreover, in the other embodiment, the substrate could be a lead frame, Polyimide, BT or the other kind of wafer substrate.

Specifically, the USB connector (11) is plugged into a USB port (42) of a computer (40) for the integrated circuit module (10) and the computer (40) electrically connected each other; the substrate (12) comprises at least a passive component (not shown in figures); the controller (13) is used in controlling transmission, processing and access of data in the memory (14); the memory (14) is used to provide readable/writable digital data and comprises an authentication code (141) as one data string for login to one server.

Preferably, the integrated circuit module (10) comprises a control unit (15) and a body case (16): the control unit (15), which is an input device such as key or touch pad, issues an electronic signal (151) to the controller (13) and monitors status of the signal received by the controller (13) for completion of setting; the body case (16) covers the partial integrated circuit module (10) to reduce risks of electronic components to be damaged.

The application program (20) comprises a communications module (21) and a transmission module (22) wherein the former is used in receiving digital information (411) of at least one data input device (41) in a computer (40) and the latter transmits both the digital information (411) received by the former and the authentication code (141) to at least one server (30) or at least one peer (31).

In practice, the application program (20) is software with an operating interface which can be downloaded from Internet or stored in a local storage device as shown in FIGS. 2 & 3, the memory (14) of the integrated circuit module (10), or a storage space (43) of the computer (40); the data input device (41) could be a text input device, a video input device, an audio input device or an image input device in general such as keypad or webcam; the peer (31) is an online terminal delivered with the same application program (20).

Preferably, the application program (20) comprises an encryption module (23), a signal detecting module (24) and an assistant positioning module (25): the encryption module (23) can conceal plain texts for a packet inaccessible under specific information unknown and guarantee security, for instance, data integrity and message authentication by means of general message authentication code or digital signature, for the authentication code (141) and the digital information (411) encrypted or decrypted; the signal detecting module (24) can issue a demand packet and wait a response packet in order to analyze the packet loss rate and the round-trip time during the application program (20) linking the server (30) or the peer (31) and display link quality briefly and graphically; the assistant positioning module (25) uses the location of a wired or wireless connection completed by the application program (20) to analyze a geographic position of a network connection.

Preferably, the server (30) comprises a peer list (301), an offline message module (302) and an offline message buffer (303). The server (30) has one database used to store the peer list (301) and the offline message buffer (303) for a relationship of the integrated circuit module (10) and the peer (31) recorded in the stored peer list (301) and management of connections between the peers (31); referring to FIGS. 5 and 6 which illustrate status of the peer (31) not login to the server (30) is verified by both the offline message module (302) and the peer list (301) and information to be issued is saved in the offline message buffer (303) for offline messages transmitted between the peers (31).

Based on preferred embodiments of the present invention for the storage device with a communications function (1), the detailed operational procedure of the present invention is explained as follows.

Referring to FIGS. 1 and 2 which illustrate an application program (20) in one memory can be operated in a computer (40) separately or automatically when a USB connector (11) of an integrated circuit module (10) is electrically plugged and connected to a USB port (42) of the computer (40). The computer (40), which is capable of linking Internet, is based on an encryption module (23) and a transmission module (22) of the application program (20) for packets transmitted to a server (30) having linked Internet and verification of an authentication code (141) and obtains a peer list (301) in the server (30) and information such as quality and position of one connection by means of a signal detecting module (24) and an assistant positioning module (25), respective. Referring to FIG. 4 which illustrates an electronic signal (151) is issued to a controller (13) via a control unit (15) and received by the application program (20) for a specific peer (31) called by means of the encryption module (23) and the transmission module (22). With an object to be called designated, both digital information (411) of a data input device (41) in the computer (40) obtained by the communications module (21) and information of a connection's position are transferred to non-decoded packets by the encryption module (23) and the transmission module (22) and transmitted to the peer (31). Referring to FIGS. 5 and 6 which illustrate a message for transmission failure is recorded to an offline message buffer (303) by an offline message module (302) of the server (30) in body case of the peer (31) not login to the server (30) and another message for transmission failure in the offline message buffer (303) is checked and transmitted by the offline message module (302) again in body case of the peer (31) login to the server (30) by means of an application program (20′) later.

As a result, the present invention with some effects different from other general live communications methods and referred to as creative work meets patentability and is applied for the patent.

It must be stressed that the said disclosures demonstrate the preferred embodiments of the present invention only and any equivalent change in disclosures, claims or drawings with respect to the present invention is still within the technical scope protected by the present invention which refers to claims hereinafter.

### BRIEF DESCRIPTIONS OF THE DRAWINGS

FIG. 1 illustrates the cross-sectional view of the preferred embodiment in the present invention.

FIG. 2 is the first block diagram of the preferred embodiment in the present invention.

FIG. 3 is the second block diagram of the preferred embodiment in the present invention.

FIG. 4 is the third block diagram of the preferred embodiment in the present invention.

FIG. 5 is the fourth block diagram of the preferred embodiment in the present invention.

FIG. 6 is the fifth block diagram of the preferred embodiment in the present invention.

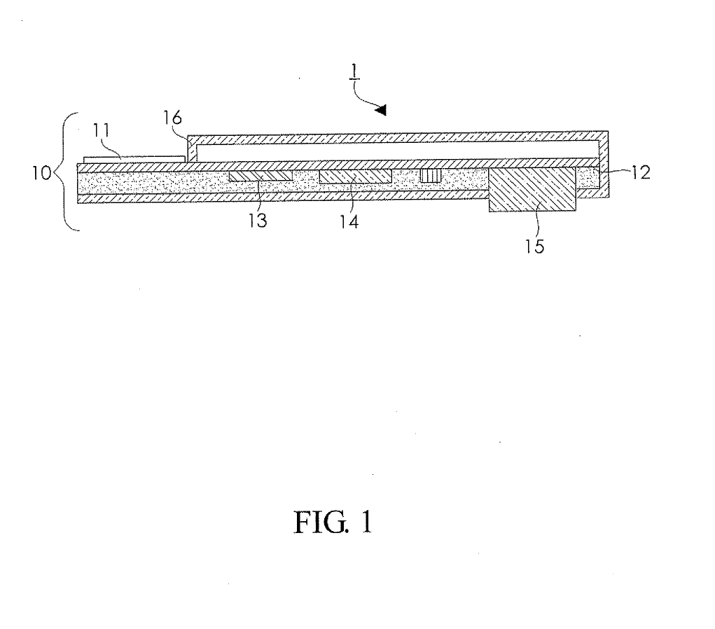

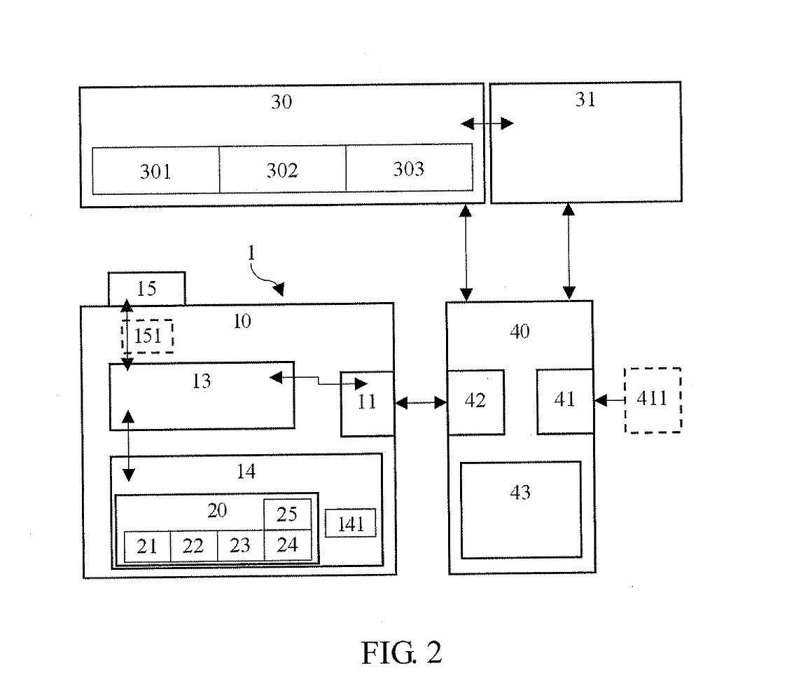

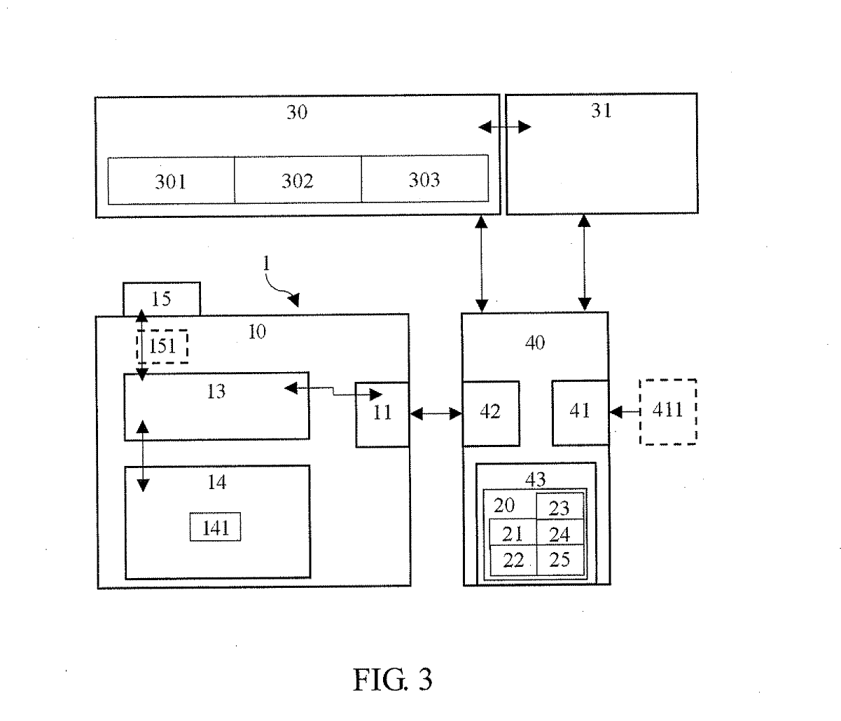

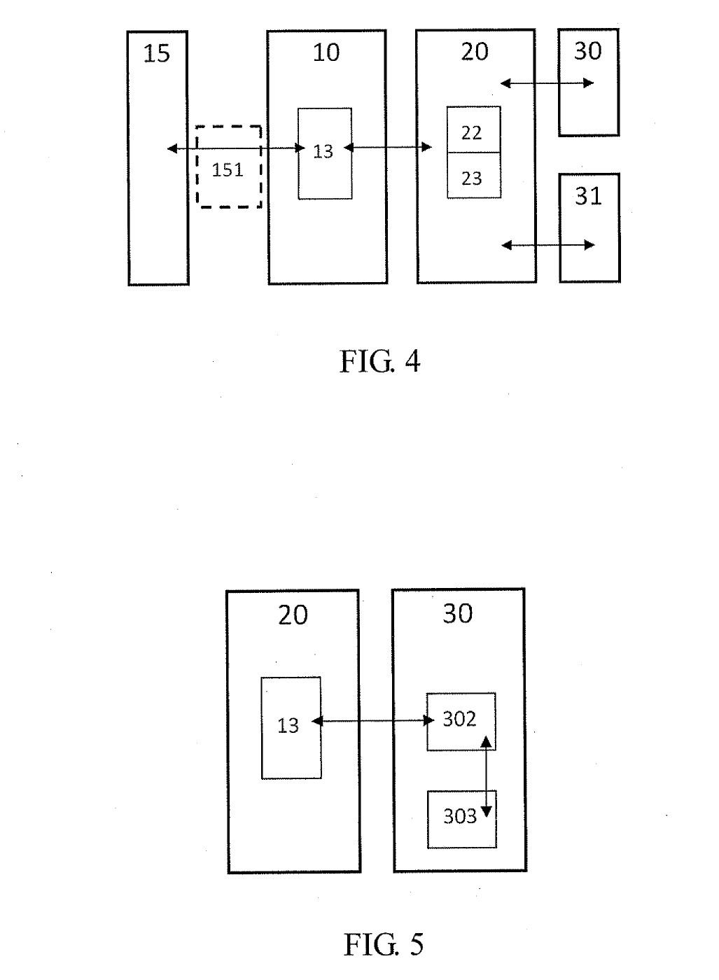

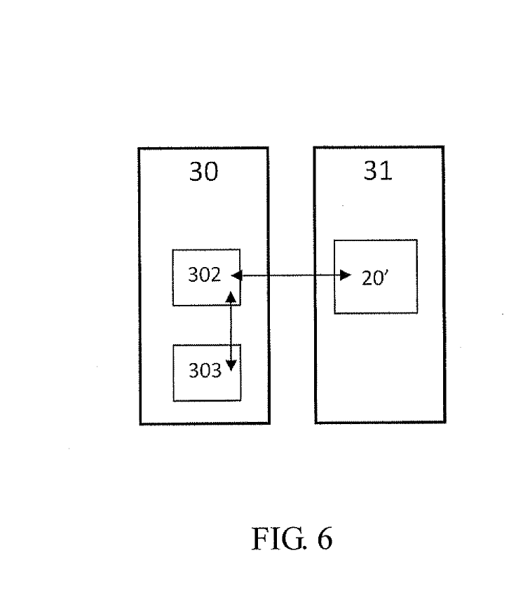

What is claimed is:

1. A storage device with a communications function (1) comprising at least an integrated circuit module (10) and an application program (20) wherein
The integrated circuit module (10) comprises at least a USB connector (11), at least a substrate (12), at least a controller (13) and at least a memory (14): the substrate (12) is used to carry the USB connector (11), the controller (13) and the memory (14) for the controller (13) electrically connected between the USB connector (11) and the memory (14) via the substrate (12) and the memory (14) comprising at least an authentication code (141);
The application program (20) comprises a communications module (21) and a transmission module (22): the communications module (21) is used to receive digital information (411) of at least a data input device (41) in a computer (40) for both the authentication code (141) and the digital information (411), which has been received by communications module (21), transmitted to at least a server (30) or at least a peer (31) by the transmission module (22).

2. The storage device with a communications function (1) according to claim 1 wherein the integrated circuit module (10) comprises a control unit (15) used in issuing an electronic signal (151) to the controller (13).

3. The storage device with a communications function (1) according to claim 1 wherein the application program (20) comprises an encryption module (23) used to encrypt or decrypt packets received or to be transmitted.

4. The storage device with a communications function (1) according to claim 1 wherein the application program (20) comprises a signal detecting module (24) used to analyze quality of one connection to the server or the peer via the application program (20).

5. The storage device with a communications function (1) according to claim 1 wherein the application program (20) comprises an assistant positioning module (25) used to analyze a geographic location of a network connection.

6. The storage device with a communications function (1) according to claim 1 wherein the server (30) comprises a peer list (301) used in managing links between the peers (31).

7. The storage device with a communications function (1) according to claim 1 wherein the server (30) comprises an offline message module (302) and an offline message buffer (303), both of which deliver offline messages transmitted between the peers (31).

8. The storage device with a communications function (1) according to claim 1 wherein the integrated circuit module (10) comprises a body case (16).
